(19) United States
(12) Patent Application Publication
(10) Pub. No.: US 2009/0038007 A1
(43) Pub. Date: Feb. 5, 2009

(54) METHOD AND APPARATUS FOR MANAGING CLIENT REVOCATION LIST

(75) Inventors: Chang-sup AHN, Seoul (KR); Yong-kuk YOU, Seoul (KR); So-young LEE, Suwon-si (KR); Bong-seon KIM, Seongnam-si (KR); Ji-young MOON, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/119,848

(22) Filed: May 13, 2008

Related U.S. Application Data
(60) Provisional application No. 60/952,945, filed on Jul. 31, 2007.

(30) Foreign Application Priority Data
Oct. 8, 2007 (KR) 10-2007-0100860

(51) Int. Cl. G06F 21/00

(52) U.S. Cl. 726/21

(57) ABSTRACT

A method and apparatus for managing a client revocation list are provided. The method includes receiving a first client revocation list from a server; and selectively discontinuing an operation of a client, based on the first client revocation list. By doing so, the method and the apparatus can securely control contents.

### CROSS-REFERENCE TO RELATED PATENT APPLICATION

This application claims priority from U.S. Provisional Patent Application No. 60/952,945, filed on Jul. 31, 2007 in the U.S. Patent and Trademark Office, and Korean Patent Application No. 10-2007-0100860, filed on Oct. 8, 2007 in the Korean Intellectual Property Office, the disclosures of which are incorporated herein their entirety by reference.

### BACKGROUND OF THE INVENTION

1. Field of the Invention

Methods and apparatuses consistent with the present invention relate to managing a client revocation list, and more particularly, to managing a client revocation list, for an environment in which a bi-directional authentication protocol cannot be used.

2. Description of the Related Art

Due to the recent rapid supply of large amounts of digital contents, there is an increased security risk to devices for processing digital contents. However, compared to a bi-directional authentication protocol using a public key based structure, Secure Sockets Layer (SSL), Transport Layer Security (TLS) or the like, a unidirectional communication environment, such as a digital cable broadcasting receiving device, a portable device, or the like, cannot verify a client revocation list during an authentication stage.

FIG. 1 illustrates diagrams showing a related art configuration of a client 100 and a connection relationship between the client 100 and other items in a digital cable broadcasting system.

A server 140 transmits digital contents to the client 100.

The client 100 includes a central processing unit (CPU) 100, a non-volatile memory 120, and an interface 130 for connecting to a portable device 160. Also, the client 100 is connected to the server 140 via a network 150 and stores or reproduces the digital contents received from the server 140. For example, the server 140 may be a transmission base station of a cable television (TV) and the client 100 may be a cable set-top box or a personal video recorder (PVR)/Digital Video Recorder (DVR) device.

The portable device 160 is connected to the client 100 via the interface 130. Also, the portable device 160 includes its own non-volatile memory (not shown) and may complement some functions of the client 100 or may independently reproduce the digital contents.

However, in a unidirectional communication environment, such as the client 100, the portable device 160, and the like, the server 140 cannot verify whether the client 100 has been hacked into or whether a period of validity has expired. Thus, it is necessary to provide the client 100 with a method of self-verifying and processing a client revocation list.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for managing a client revocation list, for securely controlling contents in an environment in which a client revocation cannot be verified by using a bi-directional protocol.

According to an aspect of the present invention, there is provided a method of managing a client revocation list, the method includes the operations of receiving a first client revocation list from a server; and selectively discontinuing an operation of a client, based on the first client revocation list.

The first client revocation list may include information about a version, a revoked client identifier, and an electronic signature.

The revoked client identifier may be individually numbered, listed within a predetermined range, or displayed by using a reference identifier and the number of clients to be revoked.

The operation of receiving the first client revocation list may include the operations of checking the electronic signature; comparing the version of the first client revocation list with a version of a second client revocation list stored in a non-volatile memory of the client if the electronic signature is valid; and recording the first client revocation list in the non-volatile memory of the client if the version of the first client revocation list is higher than the version of the second client revocation list.

The operation of selectively discontinuing the operation of the client may include the operations of reading the first client revocation list from the non-volatile memory of the client; checking the electronic signature in the first client revocation list; comparing a client identifier of the client with the revoked client identifier if the electronic signature is valid; and discontinuing the operation of the client if the client identifier and the revoked client identifier are the same.

The method may further include the operations of generating an encrypted flag for indicating revocation of the client if the client identifier and the revoked client identifier are the same; and recording the encrypted flag in the non-volatile memory of the client.

The encrypted flag may be checked whenever the client is booted and the operation of the client may be selectively discontinued based on the encrypted flag.

The operation of discontinuing the operation of the client may include the operation of permanently damaging at least one of firmware of the client, software stored in the non-volatile memory of the client, and a boot loader for loading the firmware.

The method may further include the operations of transmitting the first client revocation list to a portable device that is connected to the client and receiving a third client revocation list from the portable device.

According to another aspect of the present invention, there is provided a client revocation list management apparatus, including a receiving unit receiving a first client revocation list from a server; and a control unit selectively discontinuing an operation of a client, based on the first client revocation list.

According to another aspect of the present invention, there is provided a computer readable recording medium having recorded thereon a program for executing a method of managing a client revocation list, the method including the operations of receiving a first client revocation list from a server; authenticating the first client revocation list; and selectively discontinuing an operation of a client, based on a result of the authenticating.

### BRIEF DESCRIPTION OF THE DRAWINGS

The above and other aspects of the present invention will become more apparent by describing in detail exemplary embodiments thereof with reference to the attached drawings in which:

FIG. 1 illustrates diagrams showing a related art configuration of a client and a connection relationship between the client and other items in a digital cable broadcasting system;

FIGS. 2A and 2B are flowcharts illustrating a method of managing a client revocation list according to an exemplary embodiment of the present invention;

FIG. 3 is a diagram illustrating an example of a client revocation list;

FIG. 4 is a diagram illustrating a client revocation list management apparatus, according to an exemplary embodiment of the present invention.

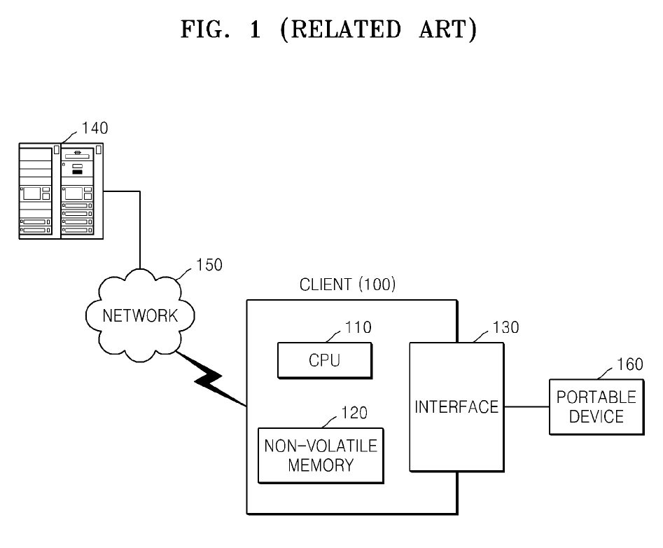

### DETAILED DESCRIPTION OF EXEMPLARY EMBODIMENTS OF THE INVENTION

The present invention will now be described more fully with reference to the accompanying drawings, in which exemplary embodiments of the invention are shown.

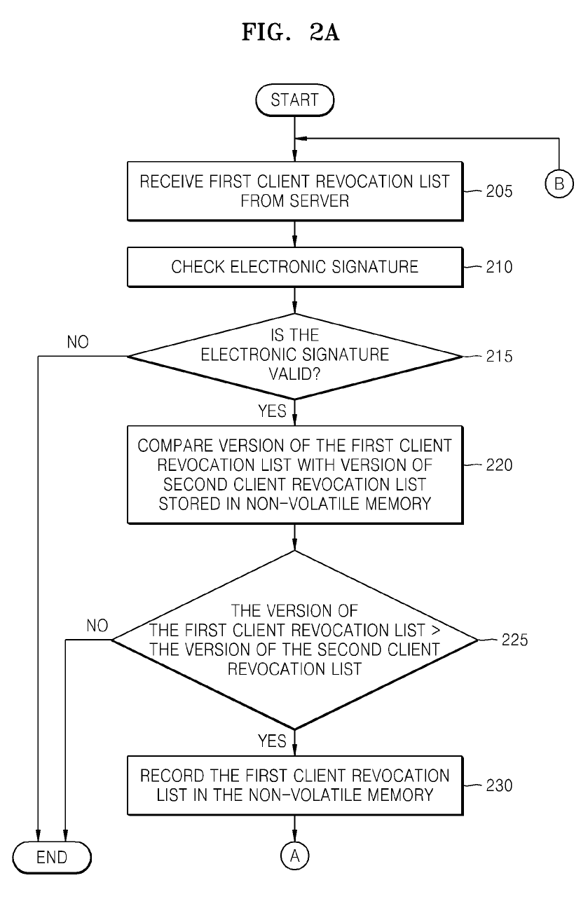

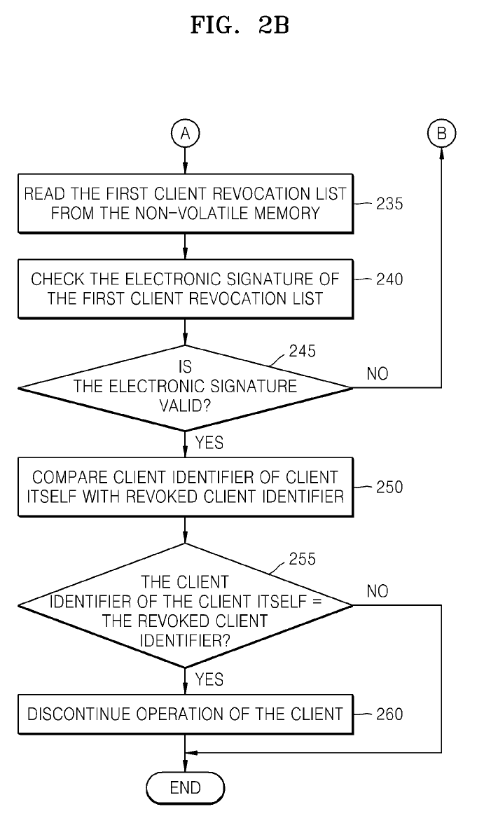

FIGS. 2A and 2B are flowcharts illustrating a method of managing a client revocation list according to an exemplary embodiment of the present invention.

FIG. 2A corresponds to a procedure for receiving and authenticating the client revocation list, which is performed by a client.

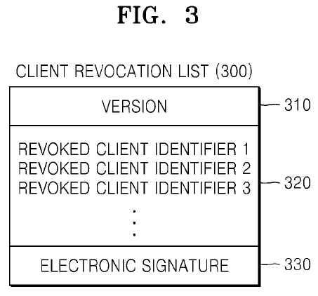

Referring to FIG. 2A, in operation 205, the client receives a first client revocation list from a server (or another portable device). The client revocation list will now be described with reference to FIG. 3. A client revocation list 300 may include information about at least one of a version 310, a revoked client identifier 320, and an electronic signature 330.

The version 310 is used to check a latest client revocation list in the case where the client receives a plurality of client revocation lists. The version 310 may be updated to a high value of version. In this case, the latest client revocation list may be easily determined by comparing the version 310 to other versions from among the plurality of client revocation lists and selecting the highest value version as the latest version.

The revoked client identifier 320 indicates an identifier of a client that is to be revoked by the server. In the case where a plurality of revoked client identifiers 320 exist, the plurality of revoked client identifiers 320 may be individually numbered, listed within a predetermined range, or designated by using a reference identifier and the number of the client to be revoked. For example, assuming that each of the plurality of revoked client identifiers 320 is 11, 12, 13, through to 100, these may be displayed with an enumeration method such as 11, 12, 13, through to 100, a range display method such as 11 through 100, or a reference identifier designation method, wherein the reference identifier is a predetermined starting point for revoking a set of identifiers, such as 20 numbers starting from 11.

The electronic signature 330 is used to check whether the received client revocation list has been provided by a faithful client revocation list provider (that is the server). The electronic signature 330 authenticates contents including the received client revocation list.

Referring back to FIG. 2A, in operation 210, the client checks an electronic signature included in the first client revocation list.

In operation 215, determines whether the electronic signature is valid. If it is determined that the electronic signature is valid, the procedure proceeds to operation 220. If it is determined that the electronic signature is invalid, reception of the client revocation list is ended.

In operation 220, the client compares a version of the first client revocation list received from the server with a version of another client revocation list (a second client revocation list) that is previously stored in a non-volatile memory of the client.

In operation 225, the client determines whether the version of the first client revocation list received from the server is higher than the version of the second client revocation list stored in the non-volatile memory. If it is determined that the version of the first client revocation list received from the server is higher than the version of the second client revocation list stored in the non-volatile memory, the procedure proceeds to operation 230. If is determined that the version of the first client revocation list received from the server is not higher than the version of the second client revocation list stored in the non-volatile memory the reception of the client revocation list is ended. In another exemplary embodiment of the present invention, if the version of the first client revocation list received from the server is the same as or lower than the version of the second client revocation list stored in the non-volatile memory, the procedure may proceed to operation 235.

In operation 230, the client records the first client revocation list in the non-volatile memory of the client. In this case, the previous second client revocation list may be deleted. By doing so, the non-volatile memory of the client may always store a latest client revocation list.

FIG. 2B corresponds to a procedure for selectively discontinuing an operation of the client, based on the received client revocation list.

In operation 235, the client reads the latest client revocation list (that is, the first client revocation list) from the non-volatile memory. In another exemplary embodiment of the present invention, if the version of the first client revocation list received from the server in operation 225 is the same as or lower than the version of the second client revocation list stored in the non-volatile memory, in operation 235, the client may read the second client revocation list from the non-volatile memory.

In operation 240, the client checks the electronic signature of the first client revocation list read in operation 235. Operation 240 is performed so as to ensure the security of the first client revocation list stored in the non-volatile memory of the client.

In operation 245, the client determines whether the electronic signature of the first client revocation list stored in the non-volatile memory of the client is valid. If it is determined that the electronic signature of the first client revocation list stored in the non-volatile memory of the client is valid, the procedure proceeds to operation 250. If it is determined that the electronic signature of the first client revocation list stored in the non-volatile memory of the client is not valid the client waits until a new client revocation list is received from the server. If the client receives the new client revocation list from the server, the procedure proceeds from operation 205.

In operation 255, the client compares its own client identifier with a revoked client identifier included in the first client revocation list. The client identifier is provided to all clients at the time of their manufacture and is stored in a non-volatile memory such as a read-only memory (ROM).

If it is determined based on the comparison that the client identifier and the revoked client identifier are the same, the procedure proceeds to operation 260. If it is determined based on the comparison that the client identifier and the revoked client identifier are not the same, the procedure is ended.

In operation 260, if the client identifier and the revoked client identifier are the same, the client discontinues the operation. In order to discontinue the operation of the client, various methods may be applied.

For example, the client may set revocation of the client in the non-volatile memory and thereby discontinue all operations. That is, in the case where the client identifier and the revoked client identifier are the same, the client generates an encrypted flag for indicating the revocation of the client. The client records the encrypted flag in the non-volatile memory of the client. Then, the client may discontinue the operation, based on the encrypted flag recorded in the non-volatile memory. Also, the encrypted flag may be checked whenever the client is booted. As a result of the check, in the case where the client is revoked, the client immediately discontinues the operation.

As another example, in the case where the client identifier and the revoked client identifier are the same, the client may permanently damage firmware of the client, software stored in the non-volatile memory of the client, or a boot loader for loading the firmware. The client may overwrite the software or the firmware with other content that cannot be executed.

Also, the method of managing the client revocation list according to the current exemplary embodiment of the present invention may further include an operation of transmitting the first client revocation list to a portable device that is connected to the client. In this operation of transmitting to a portable device, the client may transmit the latest client revocation list stored in the non-volatile memory to the portable device. Also, in another exemplary embodiment of the present invention, the client may directly transmit the client revocation list, received from the server, to the portable device.

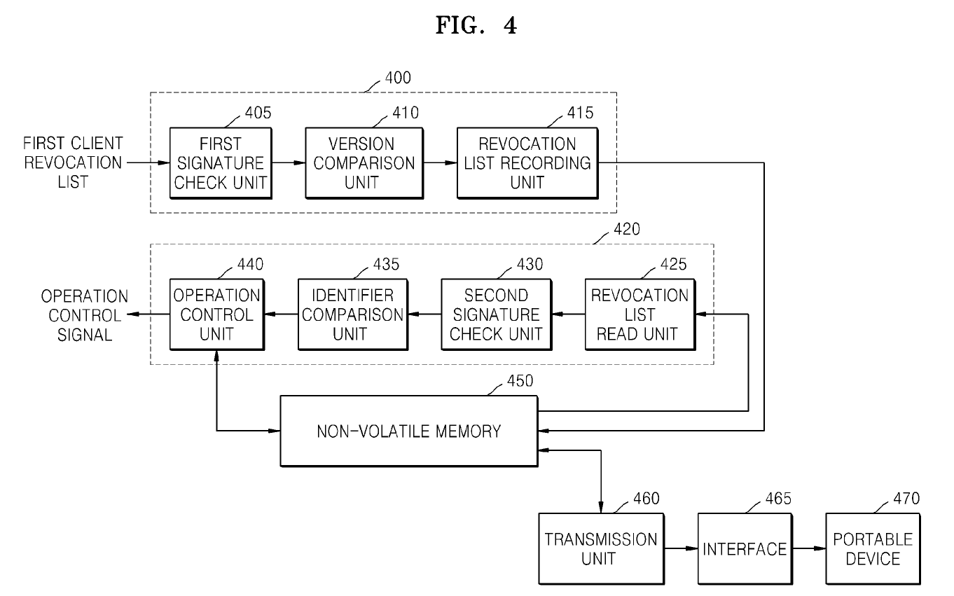

FIG. 4 is a diagram illustrating a client revocation list management apparatus, according to an exemplary embodiment of the present invention.

Referring to FIG. 4, the client revocation list management apparatus according to the current exemplary embodiment of the present invention includes a receiving unit 400 and a control unit 420.

The receiving unit 400 receives a first client revocation list from a server (or a portable device). The first client revocation list may include information about a version, a revoked client identifier, and an electronic signature. In this case, the receiving unit 400 includes a first signature check unit 405, a version comparison unit 410, and a revocation list recording unit 415.

The first signature check unit 405 checks the electronic signature included in the first client revocation list.

If it is determined that the electronic signature is valid, the version comparison unit 410 compares the version of the first client revocation list and a version of a second client revocation list stored in a non-volatile memory 450 of a client.

If it is determined that the version of the first client revocation list is higher than the version of the second client revocation list, the revocation list recording unit 415 records the first client revocation list in the non-volatile memory 450 of the client.

The control unit 420 selectively discontinues an operation of the client, based on the first client revocation list received by the receiving unit 400. The control unit 420 may include a revocation list read unit 425, a second signature check unit 430, an identifier comparison unit 435, and an operation control unit 440.

The revocation list read unit 425 reads the first client revocation list from the non-volatile memory 450 of the client.

The second signature check unit 430 checks the electronic signature of the first client revocation list read by the revocation list read unit 425.

As a result of the check performed by the second signature check unit 430, if it is determined that the electronic signature is valid, the identifier comparison unit 435 compares a client identifier of the client itself with the revoked client identifier. The client identifier of the client itself is provided to all clients at the time of their manufacture and is stored in a non-volatile memory such as a ROM.

If the client identifier and the revoked client identifier are the same, the operation control unit 440 discontinues an operation of the client. For example, the operation control unit 440 may generate an encrypted flag for indicating revocation of the client and thereby record the encrypted flag in the non-volatile memory 450 of the client. The encrypted flag is checked whenever the client is booted, and as a result of the check, the operation of the client is selectively discontinued.

Also, in another exemplary embodiment of the present invention, the operation control unit 440 may permanently damage firmware of the client, software stored in the non-volatile memory 450 of the client, or a boot loader for loading the firmware.

The client revocation list management apparatus according to the current exemplary embodiment of the present invention may further include a transmission unit 460. The transmission unit 460 may transmit the first client revocation list stored in the non-volatile memory 450 of the client to a portable device 470 via an interface 465. By doing so, the client may transmit a latest client revocation list to the portable device 470.

The present invention can receive a client revocation list from a server and discontinue an operation of the client by using the received client revocation list. By doing so, the present invention can securely control content transmitted from the server to the client.

A program for executing the method of managing the client revocation list according to the present invention can be embodied as computer readable codes on a computer readable recording medium. The computer readable recording medium is any data storage device that can store programs or data which can be thereafter read by a computer system. Examples of the computer readable recording medium include read-only memory (ROM), random-access memory (RAM), CD-ROMs, magnetic tapes, hard disks, floppy disks, flash memory, optical data storage devices, and so on. The computer readable recording medium can also be distributed over network coupled computer systems so that the computer readable code is stored and executed in a distributed fashion.

While this invention has been particularly shown and described with reference to exemplary embodiments thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of managing a client revocation list, the method comprising:
receiving a first client revocation list from a server;
authenticating the first client revocation list; and
selectively discontinuing an operation of a client, based on a result of the authenticating.

2. The method of claim 1, wherein the first client revocation list comprises information about at least one of a version, a revoked client identifier, and an electronic signature.

3. The method of claim 2, wherein the authenticating the first client revocation list comprises:
determining whether the electronic signature is valid;
comparing the version of the first client revocation list with a version of a second client revocation list stored in a non-volatile memory of the client if it is determined that the electronic signature is valid; and
recording the first client revocation list in the non-volatile memory of the client if the version of the first client revocation list is higher than the version of the second client revocation list.

4. The method of claim 3, wherein the selectively discontinuing the operation of the client comprises:
reading the first client revocation list from the non-volatile memory of the client;
determining whether the electronic signature in the first client revocation list is valid;
determining whether a client identifier of the client is the same as the revoked client identifier if it is determined that the electronic signature is valid; and
discontinuing the operation of the client if it is determined that the client identifier and the revoked client identifier are the same.

5. The method of claim 4, further comprising:
generating an encrypted flag for indicating revocation of the client if it is determined that the client identifier and the revoked client identifier are the same; and
recording the encrypted flag in the non-volatile memory of the client.

6. The method of claim 5, wherein the encrypted flag is checked whenever the client is booted and the operation of the client is selectively discontinued based on the encrypted flag.

7. The method of claim 4, wherein the discontinuing the operation of the client comprises permanently damaging at least one of firmware of the client, software stored in the non-volatile memory of the client, and a boot loader for loading the firmware.

8. The method of claim 1, further comprising transmitting the first client revocation list to a portable device that is connected to the client.

9. The method of claim 2, wherein the revoked client identifier is individually numbered, listed within a predetermined range, or displayed by using a reference identifier and the number of clients to be revoked.

10. A client revocation list management apparatus comprising:
a receiving unit which receives a first client revocation list from a server; and
a control unit which selectively discontinues an operation of a client, based on the first client revocation list.

11. The client revocation list management apparatus of claim 10, wherein the first client revocation list comprises information about at least one of a version, a revoked client identifier, and an electronic signature.

12. The client revocation list management apparatus of claim 11, wherein the receiving unit comprises:
a first signature check unit which determines whether the electronic signature is valid;
a version comparison unit which compares the version of the first client revocation list with a version of a second client revocation list stored in a non-volatile memory of the client if the first signature check unit determines that the electronic signature is valid; and
a revocation list recording unit which records the first client revocation list in the non-volatile memory of the client if the version comparison unit determines that the version of the first client revocation list is higher than the version of the second client revocation list.

13. The client revocation list management apparatus of claim 12, wherein the control unit comprises:
a revocation list read unit which reads the first client revocation list from the non-volatile memory of the client;
a second signature check unit which determines whether the electronic signature in the first client revocation list is valid;
an identifier comparison unit which compares a client identifier of the client with the revoked client identifier if the second signature check unit determines that the electronic signature is valid; and
an operation control unit which discontinues the operation of the client if the identifier comparison unit determines that the client identifier and the revoked client identifier are the same.

14. The client revocation list management apparatus of claim 13, wherein if the identifier comparison unit determines that the client identifier and the revoked client identifier are the same, the operation control unit generates an encrypted flag for indicating revocation of the client and records the encrypted flag in the non-volatile memory of the client.

15. The client revocation list management apparatus of claim 14, wherein the encrypted flag is checked whenever the client is booted and the operation of the client is selectively discontinued based on the encrypted flag.

16. The client revocation list management apparatus of claim 13, wherein the operation control unit discontinues the operation of the client by permanently damaging at least one of firmware of the client, software stored in the non-volatile memory of the client, and a boot loader for loading the firmware.

17. The client revocation list management apparatus of claim 10, further comprising a transmission unit which transmits the first client revocation list to a portable device that is connected to the client.

18. The client revocation list management apparatus of claim 11, wherein the revoked client identifier is individually numbered, listed within a predetermined range, or displayed by using a reference identifier and a number of clients to be revoked.

19. A computer readable recording medium having recorded thereon a program for executing a method of managing a client revocation list, the method comprising:
receiving a first client revocation list from a server;
authenticating the first client revocation list; and
selectively discontinuing an operation of a client, based on a result of the authenticating.
